(19) United States
(12) Patent Application Publication
(10) Pub. No.: US 2009/0220214 A1
(43) Pub. Date: Sep. 3, 2009

(54) Method and Apparatus for Reproducing Image

(75) Inventor: Go Tomita, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/363,625

(22) Filed: Jan. 30, 2009

(30) Foreign Application Priority Data
Feb. 29, 2008 (JP) 2008-051059

(51) Int. Cl. H04N 7/00; G06F 7/06; G06F 17/30

(52) U.S. Cl. 386/95; 707/1; 707/E17.014

(57) ABSTRACT

According to one embodiment, a video reproducing apparatus according to an embodiment of the present invention it is possible to reproduce an object file without making the user understand hierarchies up to a recording medium holding video and audio files or a recording apparatus, by not displaying hierarchies higher than a hierarchy including a detected object file together with a list including the object file, and by displaying a list which shows an object file at a glance.

### CROSS-REFERENCE TO RELATED APPLICATIONS

This application is based upon and claims the benefit of priority from Japanese Patent Application No. 2008-051059, filed Feb. 29, 2008, the entire contents of which are incorporated herein by reference.

### BACKGROUND

1. Field

One embodiment of the present invention relates to a video reproducing apparatus and method capable of reproducing moving images and image data supplied through a space wave or optical fiber provided by a broadcaster and distributor, or through various recording media, a network or a wireless LAN.

2. Description of the Related Art

Images and sounds to be reproduced by a video reproducing apparatus such as a digital TV capable of reproducing digital images and sounds are filed in various standards, and given various directory structures according to the standards. A recording medium to store such files and a transfer method to transfer the files are available in various forms.

Video and audio files are stored in a hard disc drive as a large-capacity storage unit, for example. A hard disc drive is incorporated in a reproducing apparatus itself, or provided by connecting to an exclusive terminal, network, universal serial bus (USB), or IEE 1394 (I-Link), or provided through a wireless LAN or Bluetooth (a registered trademark). As a recording medium (a recording device) to save video and audio files, a HDD video camera is available in addition to a semiconductor memory, such as an SD card (a memory card) and optical disc.

In the above recording medium (recording device), video and audio files are usually recorded in a directory structure peculiar to a recording device or determined by each standard.

Thus, when video and audio files supplied through an SD card are reproduced, it is necessary to search a directory connected to an SD card, and then start an application necessary for reproduction in a reproducing apparatus.

Japanese Patent Application Publication (KOKAI) No. 2008-21349 discloses a method of reproducing contents by creating a list without depending on the structure and management form of a contents management file, which are different for each model and manufacturer.

The above document discloses a method of reproducing contents regardless of the management form of a contents management different for each model and manufacturer, by assigning an identifier peculiar to a predetermined reproducing apparatus to each of the content.

However, it is also necessary to assign an identifier peculiar to a reproducing apparatus to of the each content every time, for file formats reproduced in the past and video and audio files supplied from a specific model.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a block diagram of a video reproducing apparatus according to an embodiment of the invention;

FIG. 2 is an exemplary flowchart showing a method of reproducing data (video and audio files) recorded by an external apparatus, according to an embodiment of the invention;

FIG. 3 is an exemplary diagram showing elements capable of detecting a folder structure in the method shown in FIG. 2, according to an embodiment of the invention;

FIG. 4 is an exemplary flowchart showing an exemplary procedure of detecting a folder structure and displaying an individual list shown in FIG. 2, according to an embodiment of the invention;

FIGS. 5A and 5B are exemplary diagrams each showing a file divided based on a recording method as one file, according to an embodiment of the invention; and

FIGS. 6A to 6C are exemplary diagrams each showing a procedure of adding a model name to a list of shortcut apparatus, according to an embodiment of the invention.

### DETAILED DESCRIPTION

Various embodiments according to the invention will be described hereinafter with reference to the accompanying drawings. In general, according to one embodiment of the invention, a video reproducing apparatus comprising: a hierarchical structure acquisition module configured to acquire a hierarchical structure of externally supplied information; a file detector module configured to detect whether or not an object file exists in a hierarchy lower than a root directory in the hierarchy acquired by the hierarchical structure acquisition module; and a list display module configured to displays a list including the object file detected by the file detector module.

Embodiments of this invention will be described in detail with reference to the drawings.

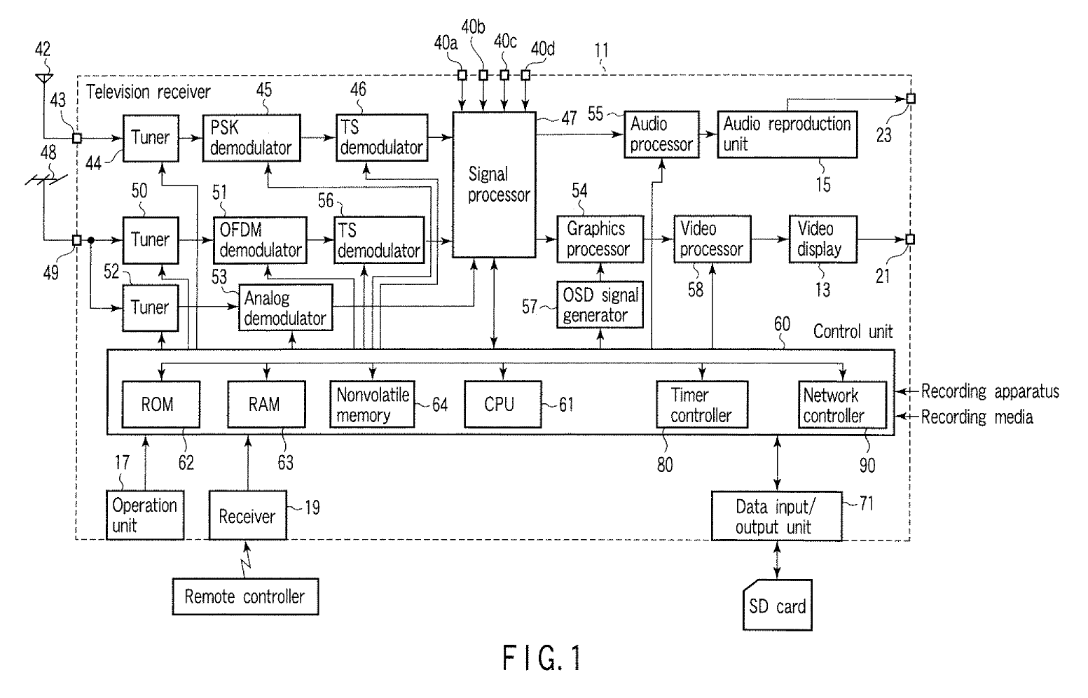

FIG. 1 shows an example of a video reproducing apparatus, to which an embodiment of the invention is applicable. A video reproducing apparatus explained hereinafter may be a television receiver provided with a video display unit (a monitor unit) in one body, or a recording/reproducing apparatus (a recorder) capable of outputting a video signal. The various modules of the systems described herein can be implemented as software applications, hardware and/or software modules, or components on one or more computers, such as servers. While the various modules are illustrated separately, they may share some or all of the same underlying logic or code.

FIG. 1 is an exemplary diagram showing an example of a block diagram of a video reproducing apparatus according to an embodiment of the invention.

A television receiver 11 includes a video display 13 which outputs a video signal to be displayed on a display unit such as a liquid crystal display panel, an audio reproducing unit 15 which outputs an audio output to be reproduced through an audio reproducing unit such as a speaker, an operation unit 17 which accepts a control instruction (a control input) signal given by a user, a remote control receiver 19 which accepts an operation information (a control input) signal given by a user through a remote controller, and a data input/output unit 71 which accepts external video and audio files through a reproducible recording medium, and outputs video and audio files to a recording medium as required by a user.

The television receiver 11 is generally controls the operations, displays, or audio outputs of the above units by a control unit module (may be called a control block, or a main board) 60.

The control unit module 60 includes a main control IC (LSI) such as a central processing unit module (CPU) 61, and controls each component by reflecting the operation information (input) from the control unit 17, or operation contents corresponding to a control signal (an input from the remote controller) sent from the remote controller and received by the remote control receiver 19.

The control unit module 60 includes a read only memory module (ROM) 62 holding a control program to be executed by the CPU 61, for example, a random access memory module (RAM) 63 to provide a work area in the CPU 61, and a nonvolatile memory module 64 to store various setting and control information.

The control unit module 60 includes a clock unit module (a timer controller) 80 to count date and time, and can control time, and reserve recording set by the user.

Hereinafter, an explanation will be given on a main signal processing system of the television receiver 11.

A satellite digital television broadcast signal received through an antenna 42 for receiving a BS/CS digital broadcast is supplied to a satellite digital broadcast tuner module 44 through an input terminal 43.

The tuner module 44 tunes a broadcast of a desired channel by a control signal from the control unit module 60, and outputs the tuned broadcast signal to a phase shift keying (PSK) demodulator module 45.

The PSK demodulator module 45 demodulates the broadcast signal tuned by the tuner module 44, based on the control signal from the control unit module 60, obtains a transport stream (TS) including a desired program, and outputs the transport stream to a TS demodulator module 46.

The TS demodulator module 46 performs TS demodulation of a transport stream multiplexed signal by the control signal from the control unit module 60, outputs digital video and audio signals of a desired program to a signal processor module 47, and outputs various data (service information) to obtain digital broadcast programs, electronic program guide (EPG), program attribute information (program genre, etc.), and subtitle information, to the control unit module 60.

A terrestrial digital television broadcast signal received through an antenna 48 for receiving a terrestrial broadcast is supplied to a terrestrial digital broadcast tuner module 50 through an input terminal 49.

The tuner module 50 tunes a broadcast of a desired channel by a control signal from the control unit module 60, and outputs the tuned broadcast signal to an orthogonal frequency division multiplexing (OFDM) demodulator module 51.

The OFDM demodulator module 51 demodulates the broadcast signal tuned by the tuner module 50 by the control signal from the control unit module 60, obtains a transport stream including a desired program, and outputs the transport stream to a TS demodulator module 56.

The TS demodulator module 56 performs TS demodulation of a TS multiplexed signal under the control of the control unit module 60, outputs digital video and audio signals of a desired program to a signal processor module 47, and outputs various data to obtain digital broadcast programs, electronic program guide (EPG), and program attribute information (program genre, etc.), to the control unit module 60.

A terrestrial analog television broadcast signal received through the antenna 48 for receiving a terrestrial broadcast is supplied to a terrestrial analog broadcast tuner module 52 through the input terminal 49, thereby a broadcast signal of a desired channel is tuned. The broadcast signal tuned by the tuner module 52 is demodulated to analog video and audio signals by an analog demodulator module 53, and then output to the signal processor module 47.

The signal processor module 47 selectively performs predetermined digital signal processing for the digital video and audio signals supplied from the PSK demodulator module 45 and OFDM demodulator module 51, and outputs the processed signals to a graphics processor module 54 and an audio processor module 55.

The signal processor module 47 is connected to two or more (four in the drawing) input terminals 40a, 40b, 40c and 40d. These input terminals 40a to 40d permit external input of analog video and audio signals from the outside of the broadcast receiver 11.

The signal processor module 47 selectively digitizes the analog video and audio signals supplied from the analog demodulator module 53 and input terminals 40a to 40d, performs predetermined digital signal processing for the digitized video and audio signals, and outputs the processed signals to the graphics processor module 54 and audio processor module 55.

The graphics processor module 54 has a function to output an OSD signal generated by an on-screen display (OSD) signal generator module 57 by superposing it on the digital video signal supplied from the signal processor module 47. The graphics processor module 54 can selectively output the video signal output from the signal processor module 47 and the OSD signal output from the OSD signal generator module 57, and can output both signals by combining them so that each composes a half of a screen.

The OSD signal output from the OSD signal generator module 57 can also be output in being superposed on an ordinary video display in a semitransparent state (to pass a part of an ordinary video signal), if a parameter for a blending is set.

When a broadcast signal includes a subtitle signal and a subtitle is displayable, the graphics processor 54 superposes a subtitle on a video signal, based on the subtitle information and the control signal from the control unit module 60.

The digital video signal output from the graphics processor module 54 is supplied to a video processor module 58. The video processor module 58 converts the digital video signal supplied from the graphics processor module 54, to an analog video signal to be reproducible as a video (moving image/still image) output on a display unit (a monitor unit) connected to an output terminal 21 of the video display unit 13.

The output terminal 21 may be omitted, and a monitor unit (a display unit) may be directly connected to the video display unit 13. The output terminal 21 may be connected to a DVD recorder using a DVD-standard optical disc as a recording medium, or a video recorder using a conventional videotape as a recording medium.

The audio processor module 55 converts the digital audio signal supplied from the signal processor, to an analog audio signal to be reproducible as a voice/audio output through a speaker or a headphone connected to the output terminal 23 of the audio reproducing unit 15. The output terminal 23 may be omitted, and a speaker may be directly connected to the audio reproducing unit 15.

The data input/output unit 71 is a card reader/writer or memory slot, into which a semiconductor memory (a memory card) such as an SD card is inserted, and obtains data (video and audio files) recorded by an external device, or transfers video and audio files to a recording medium (an SD card) as required by the user. The data input/output unit 71 may be an interface such as a universal serial bus (USB), or a USB mass storage connected to the data input/output unit 71. The data input/output unit 71 may be a wireless communication apparatus such as Bluetooth (a registered trademark)

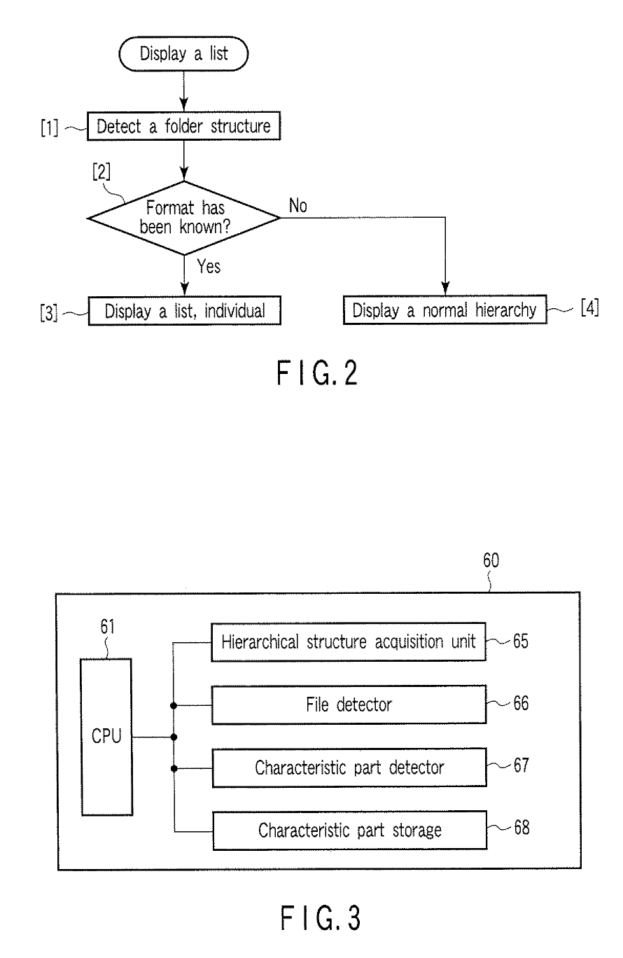

Next, an explanation will be given on an example of a method of reproducing data (video and audio files) recorded by an external device by using the video reproducing apparatus briefly explained in FIG. 1, by using FIG. 2.

When an SD card (a recording medium) is inserted into the data input/output unit 71, analysis is performed at first on a recording hierarchy of the data stored in the SD card, or video and audio files (block [1]).

When a folder structure (hierarchy) is detected, whether or not the hierarchical structure is a know format (reproduced in the past) is checked (block [2]).

The detected hierarchical structure is a known format (Yes in block [2]), an individual list which can display only an object file (a file name) with respect to the data held in the (inserted) SD card (recording medium). Namely, the name of the contents (video and audio files) is individually listed (block [3]). The detected folder structure (hierarchical structure) is an unknown format not reproduced in the past (No in block [2]), a file structure recorded by an external device is displayed (block [4]).

In this case, the user is prompted to search a root directory for the displayed (obtained) folder structure to find an object file. Namely, the user is requested to find out an object file (to be reproduced).

In contrast, a file recorded by a digital camera or a movie (a video camera) is managed in a directory structure determined by each apparatus. Such a file is sometimes given a specific folder structure that is branched into two or more directories, and it is not necessarily easy for the user to find out an object file.

FIG. 3 shows an example of detection of a folder structure briefly explained in FIG. 2, and elements to display an individual list based on the detection result.

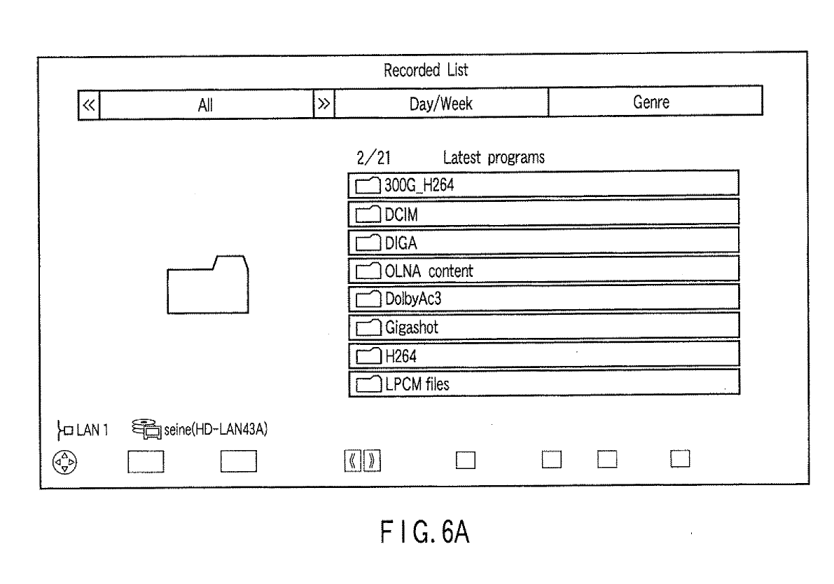

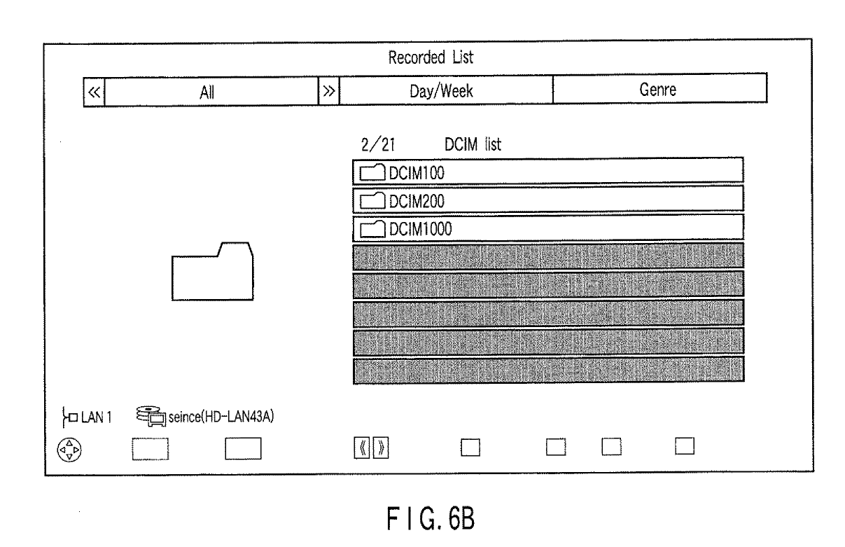

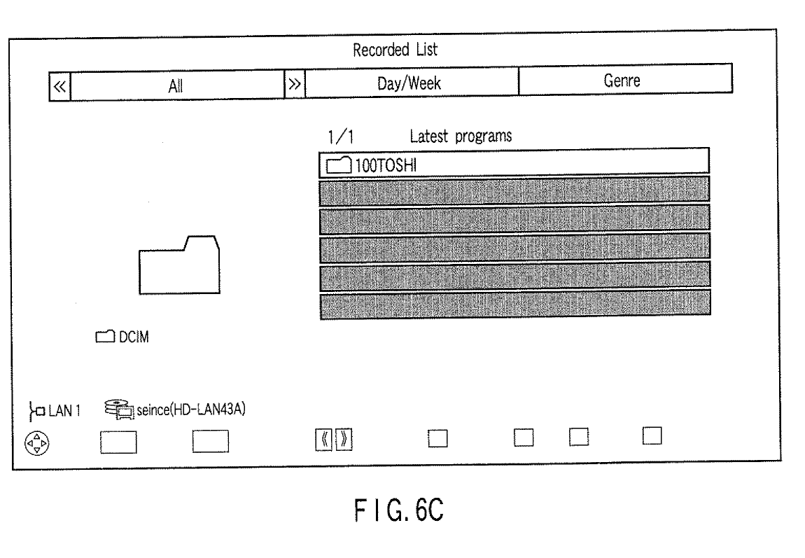

The control unit module 60 includes, in addition to the above explained CPU module 61, a hierarchical structure acquisition unit module 65 to acquire a hierarch structure of contents (video and audio) supplied from an external medium or other apparatus on a network, a file detector module 66 to detect whether or not an object file exists in a lower-order hierarchy in the hierarchies acquired by the hierarchical structure acquisition unit, a characteristic part detector module 67 to detect whether or not a characteristic part peculiar to the object file is stored in a lower-order hierarchy in the hierarchies acquired by the hierarchical structure acquisition unit module, and a characteristic part storage module 68 to hold the characteristic part detected by the characteristic part detector module 67, as explained later by using FIGS. 6A to 6C.

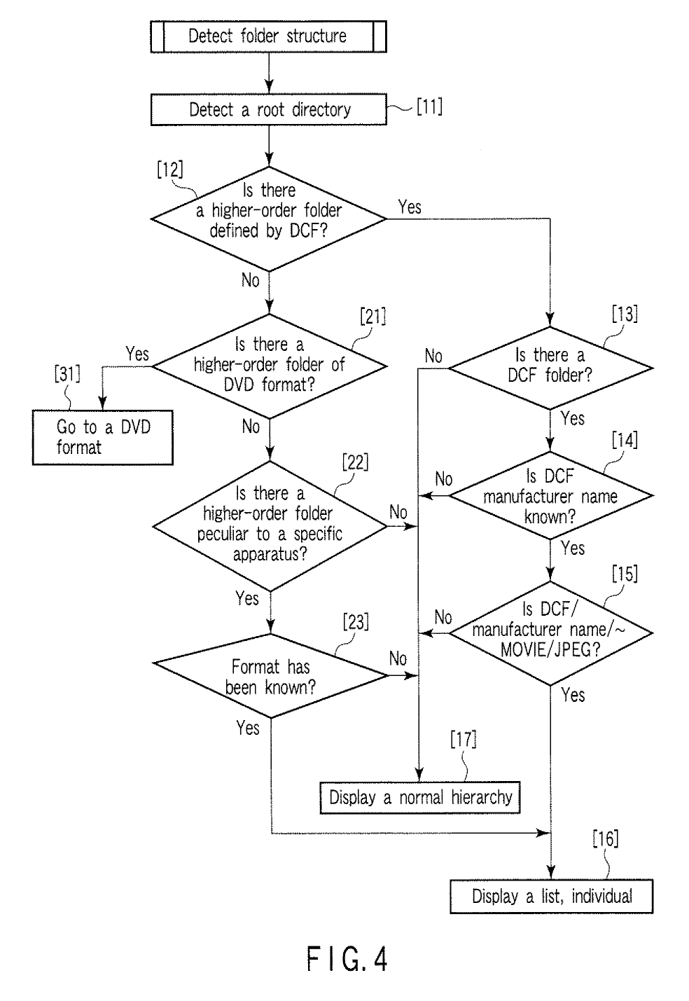

FIG. 4 is a flowchart explaining the details of detection of a folder structure briefly explained in FIG. 2, and display of an individual list.

Whether or not at least one hierarchy (folder) is included in an SD card (a recording medium) inserted into the data input/output unit 71 is checked in step “Detect a root directory” (block [11]).

When a root directory is detected, first a check is made to determine whether or not there is a higher-order folder defined based on a DCF (design rule for camera file system) or Exif (exchangeable image file format) (block [12]).

When a folder structure defined based on the DCF (or the Exif) is detected, whether or not the DCF (or the Exif) folder is included is checked (block [13]).

When it is detected that the DCF (or the Exif) folder is included, whether or not the name of the folder includes an identifier or extension indicating a manufacturer name/a model name/specific information (indicating that a file is reproducible by a video reproducing apparatus) is checked (block [14]). An identifier including an extension can be called an identifier.

When it is detected that the DCF folder name includes an identifier or extension indicating a manufacturer name/a model name/specific information (indicating that a file is reproducible by a video reproducing apparatus), a check is made to determine whether or not the DCF folder name includes a lower-order hierarchical structure, for example a file format given as “DCF/manufacturer/model/˜˜˜”, for example, a specific file name such as “/MOVIE” or “/JPG.” (block [15]).

As described above, when specific information such as “DCF/ABC (a manufacturer name)/1111 (a model name)/JPG”, or a file name displayed based on an identifier or extension is detected in the SD card set in the data input/output unit 71, it is judged that a file “reproduced in the past” or “reproducible by a video reproducing apparatus” is included (exists), and an “individual list” is displayed (block [16]).

If a folder name or a file name is not detected in any one of block [13] to block [15], the user is prompted to search a root directory for the displayed (obtained) folder structure to find an object file (Display an ordinary directory.) (block [17]).

Even if a folder structure defined based on the DCF (or the Exif) is not detected (No in block [12]), it is possible to specify a file by using an identifier or extension indicating “an index file (.Index/_ID)” or “information file (_IFO)”. For example, it is possible to check the existence of a higher-order folder of DVD format that is a widely used file format standard, or a higher-order folder of an identifier or extension indicating a standard (a format) peculiar to a specific apparatus (block [21], block [22]).

For example, if it is detected that a higher-order folder of a DVD format is included (Yes in block [21]), a file standard can be specified based on its identifier or extension, by detecting chapter information or reproducible range information belonging to a file, or an identifier or extension indicating an attachment of a thumbnail image, according to the DVD format. More specifically, when an image is recorded in a DVD-VR mode of DVD standard, for example, the model name of a recorder that records the contents (video and audio) can be specified by referring to “Video Recording Manager-ID (DVDVR_MGI)” that is one of management files included in an “information file (._IFO)” (block [31]).

In block [21] and block [22], even if neither a DVD-format higher-order folder nor a standard (format) higher-order peculiar to a specific apparatus is found, when it is detected that a file “reproduced in the past” or “reproducible by a video reproducing apparatus” is included (exists), or when a “known format” is found (Yes in block [23]), an “individual list” is displayed (block [16]).

In FIGS. 2 and 4, an SD card (a memory card) is set as an external medium in the data input/output unit 71. An “individual list” can be displayed also for the contents (video and audio files) recorded on a recording medium (HDD) of other recorder units, which can transfer data through a network controller module 90 conformable to a digital living network alliance (DLNA, a registered trademark) standard, or a not-shown bluetooth (a registered trademark).

An individual list, or a list showing an object file at a glance without showing hierarchies higher than the object file, can be obtained (displayed) by appropriately processing the detection result obtained by the control unit module 60, CPU module 61, hierarchical structure acquisition unit module 65 and file detector module 66 by the OSD signal generator module 57 and graphics processor module 54, to be displayable in being superposed on a video signal supplied from the signal processor module 47, for example.

As described above, by creating and displaying an “individual list” by searching a format or file format to reproduce a file “reproduced in the past” or “reproducible by a video reproducing apparatus”, for the contents recorded by an external device (a recording medium) or a storage unit of an apparatus connected to a network, various files recorded by a digital camera or movie (video camera) can be easily reproduced without requiring the user to do a complicated operation.

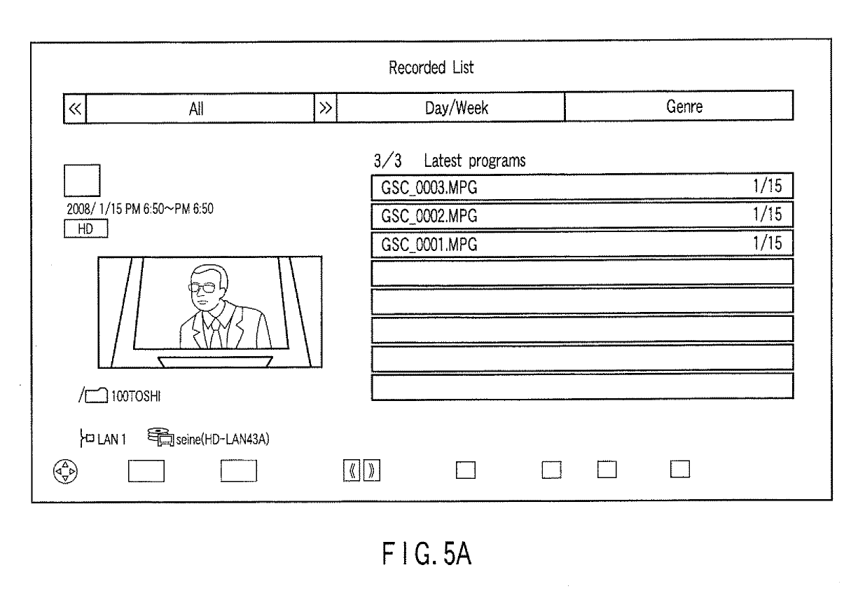

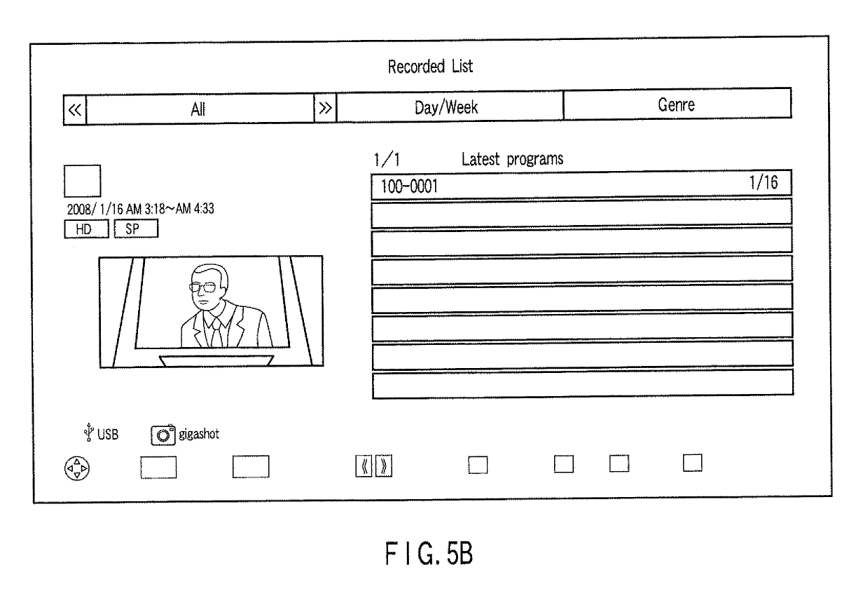

The above “individual list” can be displayed as one file, if it is created after analyzing an “information file (._IFO)” (because, the (._IFO) file includes information that makes discontinued points seemed to be one point). As for a file larger than a maximum size (4 GB) caused by a compression method of moving picture experts group (MPEG)-2 used in a DVD recorder, or a file allocation table (EAT) FAT 32 in an operating system (OS), for example, even two or more files divided by about six hours when MPEG-2 is recorded at a standard rate, and divided by about three hours when recorded at a higher-order rate, as shown in FIG. 5A, can be displayed as one file (not to be seemed as divided files) as shown in FIG. 5B.

Further, a model name specified by the method of creating an “individual list (displaying an object file only)” explained by using FIG. 4 can be added to a list of shortcut apparatus held in the nonvolatile memory (NVM) 64 of the control unit 60 (when an apparatus is connected at and after the 2nd time, a file is directly reproducible, and usually when an apparatus is connected (set), a model name or an apparatus group name such as a “digital camera” is displayed), if it is set by the user (by the user setting).

When a model name is added to a list of shortcut apparatus, for example, an ordinary directory (folder) structure is obtained for all apparatus, as shown in FIG. 6A, access is made sequentially from a higher-order directory structure for each apparatus group to a lower-order folder up to a directory (folder) storing a file to be registered (an object file), as shown in FIG. 6B, and when the file (object file) is found (reached), the folder structure (holding the file) is registered in (added to) the shortcut list, as shown in FIG. 6C. In this case, the name of a folder holding the object file is automatically set as a folder name to be registered, or it can be set (rewritten) by the user.

A model name can also be added to a list of shortcut apparatus by obtaining an ordinary directory (folder) structure for all apparatus, as shown in FIG. 6A, accessing sequentially from a higher-order directory structure for each apparatus group to a lower-order folder up to a directory (folder) storing a file to be registered (an object file), obtaining a manufacturer name and model name recorded in an index information file (._IFO) of that file or in an index information file, giving an optional folder name, and registering it in a shortcut list.

By the above method, contents (video and audio files) recorded in recording media (HDD) of other recorders connected through the network controller 90, or “bonus vide” provided by a software supplier as a bonus for a purchaser of commercially available DVD software permitted to get (view), can be easily reproduced as “bonus video”, even in a complicated reproduction form, for example, reproduction by a video reproducing apparatus (the present apparatus) different from the apparatus for which the bonus video is obtained.

By the above “registration in a shortcut list”, a file to be reproduced by the user can be easily reproduced by setting a recording medium storing the contents (video and audio) recorded by an external medium or apparatus registered in the list, or by connecting to a network. In this case, the setting of the recording medium storing the contents (video and audio) recorded by an external medium or apparatus registered in the list is displayed on the display connected to the video display unit 13.

Further, by the above “registration in a shortcut list”, even for a file recorded by another apparatus manufactured by the same manufacturer as of the apparatus already used by the user, or an apparatus to be sold in the future (an apparatus not previously registered as a reproducing apparatus), the conventional procedures, “searching an ordinary directory (folder) structure”, “accessing a lower-order folder”, and “reproducing an object file” become unnecessary, and the file can be easily reproduced at the time when a similar folder name is found.

As explained herein, by using one of the embodiments of the invention, it is possible to easily reproduce an object file (to directly reach a folder holding an object file) without understanding a complicated directory structure.

Further, it is possible to reproduce a file (data) recorded by an apparatus not previously registered as a reproducing apparatus, by a simple reproducing procedure.

Namely, by using one of the embodiments of the invention, the user can easily reproduce a file, which has a directory structure determined by each apparatus and mostly different for each manufacturer, and is recorded by various digital cameras and movies (video cameras), without understanding a complicated directory (folder) structure. Therefore, the user's operability and convenience are greatly increased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video reproducing apparatus comprising:
a hierarchical structure acquisition module configured to acquire a hierarchical structure of externally supplied information;
a file detector module configured to detect whether or not an object file exists in a hierarchy lower than a root directory in the hierarchy acquired by the hierarchical structure acquisition module; and
a list display module configured to displays a list including the object file detected by the file detector module.

2. The video reproducing apparatus of claim 1, wherein when the object file is detected by the file detector module, at least one of hierarchies higher than the hierarchy including the object file is not displayed together with the list including the object file.

3. The video reproducing apparatus of claim 1, wherein when the object file is detected by the file detector module, not all hierarchies higher than the hierarchy including the object file are displayed, but the list including the object file is displayed.

4. A video reproducing apparatus comprising:
a hierarchical structure acquisition module configured to acquire a hierarchical structure of externally supplied information;
a characteristic part detector module configured to detect whether or not an object file stored in a hierarchy lower than a root directory in the hierarchy acquired by the hierarchical structure acquisition module includes an identifier peculiar to the object file; and
a characteristic part module configured to store the identifier peculiar to the object file detected by the hierarchical structure acquisition module associating with an information supply source.

5. The video reproducing apparatus of claim 4, wherein the video reproducing apparatus is a display unit to display a reproducing image.

6. The video reproducing apparatus of claim 4, wherein when an apparatus previously registered as a reproducing apparatus is connected, the video reproducing apparatus adds a signal for displaying a name of apparatus connected to the registered apparatus, to a reproducing video signal.

7. A video reproducing method comprising:
acquiring a hierarchical structure of externally supplied information;
detecting an object file by accessing hierarchies lower than a root directory in the acquired hierarchy; and
hierarchies higher than the detected hierarchy including the object file are not displayed together with the list including the object file.
